(19) United States
(12) Patent Application Publication
(10) Pub. No.: US 2023/0164596 A1
(43) Pub. Date: May 25, 2023

(54) ALARM LOG MANAGEMENT SYSTEM AND METHOD DURING FAILURE IN O-RAN

(71) Applicant: Sterlite Technologies Limited, Gurugram (IN)

(72) Inventors: Savnish Singh, Gurugram (IN); Narendra Gadgil, Gurugram (IN); Nitesh Kumar, Gurugram (IN)

(73) Assignee: Sterlite Technologies Limited, Gurugram (IN)

(21) Appl. No.: 17/697,355

(22) Filed: Mar. 17, 2022

(30) Foreign Application Priority Data
Nov. 24, 2021 (IN) 202111054360

(51) Int. Cl. H04W 24/04

(52) U.S. Cl. CPC H04W 24/04

(57) ABSTRACT

The present disclosure provides a method and a system for managing fault using logged information associated with at least one alarm in an open radio access network (O-RAN) (100). The method includes creating a first alarm list comprising a first set of information associated with the at least one alarm, wherein the first set of information comprises a historical logged information associated with any one or both of activation and deactivation of the at least one alarm. Further, the method includes enabling an access to the first alarm list.

### TECHNICAL FIELD

The present disclosure relates to a wireless communication system, and more specifically, relates to an alarm log management system and method for a radio unit (RU) of a base station during failure in an O-RAN (Open-Radio Access Network).

### BACKGROUND

A fault management, according to O-RAN Alliance Working Group 4 Management Plane Specification Version 07.00, is responsible for sending alarm notifications to a configured subscriber, which will typically be a NETCONF (Network Configuration Protocol) client unless an O-RU (Open Radio Unit) supports the configured subscription capability, when the configured subscriber may be an Event-Collector. FM contains Fault Management Managed Element and via this Managed Element, alarm notifications can be disabled or enabled.

In general, whenever the system encounters an issue or fault in the system, it needs to report to the Operator or administrator, so that the issue can be resolved as soon as possible and normal operation can be resumed or a critical operation should not impact the network. This reporting is detailed below.

A NETCONF server is responsible for managing an “active-alarm-list”. In ORAN, alarms with severity “warning” are excluded from this active alarm list. When an alarm is detected, it is added to this active alarm list; when the alarming reason disappears then the alarm is cleared- removed from the “active-alarm-list”. Furthermore, when the element that was the “fault-source” of an alarm is deleted then all related alarms are removed from the “active-alarm-list”.

As shown in FIG. 1, the O-RU is responsible to send an alarm-notification to a configured subscriber when: the NETCONF client has established a subscription to alarm notification, a new alarm is detected (this can be the same alarm as an already existing one, but reported against a different “fault-source” than the existing alarm) and an alarm is removed from the active alarm list.

The removal of alarms from the active alarm list due to deletion of the “fault-source” element is considered as clearing and causes sending of the alarm-notification to the configured subscriber. This applies to alarms that were explicitly related to the deleted “fault-source” element. The rationale for such is to avoid misalignment between NETCONF clients when one NETCONF client deletes an element.

As shown in FIG. 2, the O-RU reports the alarm notification only for new active or cancelled alarms of specific severity, not all active alarms.

The NETCONF client can “subscribe” to the fault management element by sending create-subscription, to the NETCONF server. Thus, the alarm notifications reported by the NETCONF server contain the “fault-source” element which indicates the origin of an alarm. In general, values of “fault-source” are based on names defined as YANG elements for example a source (i.e., fan, module, PA, port, etc.), indicating the origin of the alarm within the O-RU. Value of “fault-source” is based on the element name

In case, the NETCONF server reports an unknown “fault-source”, the NETCONF client can discard this alarm notification. That is, the source (other than when an element is within the O-RU) value of fault-source may be empty or may identify the most likely external candidate; for example, antenna line. Further, alarms with different “fault-id”, “fault-source” or “fault-severity” are independent. Multiple alarms with the same “fault-id” may be reported with different “fault-source” and multiple alarms with the same “fault-source” may be reported with different “fault-id”.

Further, when an alarm with a “fault-id” and a “fault-source” is reported with a “fault-severity” and its severity of alarm condition is upgraded or degraded, the NETCONF server reports a new alarm with the same “fault-id” and the same “fault-source” with the upgraded or degraded “fault-severity” with “is-cleared”:: FALSE and clears the previous alarm with the report of the “fault-id”, “fault-source” and “fault-severity” with “is-cleared”:: TRUE.

The range of “fault-id” is separated into common and vendor specific. The common fault-ids are known in the art and more numbers will be used in the future. The vendor specific range for the fault-id shall be [1000 . . . 65535].

Alarm notifications reported by the NETCONF Server contain names of the “affected objects” which indicate elements affected by the fault. In case, the origin of the alarm is within the O-RU, other elements than “fault-source” which will not work correctly due to the alarm are reported via the “affected objects”. In case, the origin of the fault is outside of the O-RU, the O-RU elements which will not work correctly due to the fault are reported via the “affected-objects”.

As seen above, generally, active alarms except for the alarms with ‘Warning’ as severity on the server are reported to the client with the help of Notifications supported by NetCONF/RestCONF protocol and the alarm data is kept into a list containing the currently active alarms on the server. Once the Alarms are cleared from the server, a notification is sent to the client and the entry from Active Alarms is removed. Some of the prior art references are given below:

U.S. Pat. No. 10,284,730B2—In one or more embodiments, the SDN Network 150 can support legacy and emerging protocols through the use of adapters, including, but not necessarily limited to, configurator or adapters that can write to the network elements, and listening adapters that can collect statistics and alarms for the data collection and analytic engine as well as for fault and performance management. Modularity of the Manager SDN Controller 130 can allow the enable functions, such as compiling, service control, network control, and data collection and analytics to be optimized and developed independently of the specific vendor network equipment being controlled.

U.S. Pat. No. 8,031,726B2—Among other things, the gateway operational management software 1001 monitors the state and performance of the gateway device 10, the services delivered to the user's endpoint devices 11 and the state and performance of the endpoint devices 11 attached to the gateway device 10. Based on these functions, the gateway operational management software 1001 generates operational information in the form of billing records, statistical information, alarms, and logs that are stored locally on the gateway device's 10 hard drives 154. As described above, the fault manager 120 f is part of the gateway operational management software 1001 (FIG. 5). The fault manager 120 f, also known as the alarm manager, manages the alarm information generated by the gateway device 10 and its associated endpoint devices 11. FIG. 8 is a high-level flow diagram of an exemplary gateway device 10 that collects, manages, and stores the alarms associated with the services provided by or through the exemplary gateway device.

JP6382225B2—Third, a human-machine interface (HMI) and supervisory control and data acquisition (SCADA) come on top of the controller. In addition to the HMI/SCADA station, other applications such as history records, alarm managers, and many other applications run on dedicated workstations. In addition, the necessary changes in control strategy are implemented at the technical workstation and then deployed from the technical workstation. All such computers are connected to the controller through a control network.

While the prior arts cover various solutions for fault/failure management of the O-RU, however these solutions are not effective, since there is no record of all the generated and/or cleared alarms for retrieval by a user at a later time. In light of the above-stated discussion, there is a need to overcome the above stated disadvantages.

### OBJECT OF THE DISCLOSURE

A principal object of the present disclosure is to provide an alarm management system and method for fault/failure management in that creating an alarm list comprising a historical logged information.

Another object of the present disclosure is to provide historic logged alarm events periodically and/or on-demand to a client.

### SUMMARY

Accordingly, the present disclosure provides a method and a system for managing fault using logged information associated with at least one alarm in an open radio access network (O-RAN). The method is implemented at a NETCONF server. The method includes creating a first alarm list comprising a first set of information associated with the at least one alarm, wherein the first set of information comprises a historical logged information associated with any one or both of activation and deactivation of the at least one alarm. The historical logged information associated with the activation comprises at least one of: time stamp information of an alarm activation and operation failure information causing the alarm activation and the historical logged information associated with the deactivation comprises the time stamp information of an alarm deactivation.

The method further includes enabling an access to the first alarm list. The access to the first alarm list is enabled by maintaining a client-server relationship over HTTP-based Representational State Transfer Configuration Protocol (RESTCONF) protocol and enabling the access to the first alarm list using the RESTCONF protocol, wherein the RESTCONF provides a programmatic interface based on standard mechanisms for accessing configuration data, state data, data-model-specific Remote Procedure Call (RPC) operations, and events, defined in YANG model. The method further comprises transmitting an alarm notification comprising affected objects indicating elements affected by a fault.

In order to manage fault(s), the method includes maintaining a second set of information in a second alarm list, wherein the second set of information comprises at least one active alarm. The method further comprises copying the historical logged information to an SFTP (Secure File Transfer Protocol) server and transmitting a path of a copied location of the SFTP server to one or more connected clients.

Still further, the method comprises transmitting a notification with the path of the copied location to the one or more connected clients when the historical logged information is copied to a remote location on the SFTP server.

In another aspect, the fault management system for managing fault using logged information associated with at least one alarm in an open radio access network (ORAN) comprises a fault management unit (FMU). The FMU is configured to create a first alarm list comprising a first set of information associated with the at least one alarm, wherein the first set of information comprises a historical logged information associated with one of: activation and deactivation of the at least one alarm and configured to enable access to the first alarm list.

The access to the first alarm list is enabled by the FMU by maintaining a client-server relationship over HTTP-based Representational State Transfer Configuration Protocol (RESTCONF) protocol and enabling the access to the first alarm list using the RESTCONF protocol, wherein the RESTCONF provides a programmatic interface based on standard mechanisms for accessing configuration data, state data, data-model-specific Remote Procedure Call (RPC) operations, and events, defined in YANG model. The FMU is further configured to transmit an alarm notification comprising affected objects indicating elements affected by a fault.

In order to manage fault(s), the FMU maintains a second set of information in a second alarm list, wherein the second set of information comprises at least one active alarm when the at least one active alarm is resolved.

Additionally, the FMU is configured to copy the historical logged information to an SFTP (Secure File Transfer Protocol) server, share a path of a copied location of the SFTP server to one or more connected clients and transmit a notification with the path of the copied location to the one or more connected clients when the historical logged information is copied to a remote location on the SFTP server.

The fault management system also comprises an artificial intelligence/machine learning (AI/ML) unit that identifies at least one future failure event associated with the at least one alarm using the first alarm list and determines at least one resolution to the at least one future failure event.

These and other aspects herein will be better appreciated and understood when considered in conjunction with the following description and the accompanying drawings. It should be understood, however, that the following descriptions are given by way of illustration and not of limitation. Many changes and modifications may be made within the scope of the invention herein without departing from the spirit thereof.

### BRIEF DESCRIPTION OF FIGURES

The invention is illustrated in the accompanying drawings, throughout which like reference letters indicate corresponding parts in the drawings. The invention herein will be better understood from the following description with reference to the drawings, in which:

FIGS. 1 and 2 are sequence diagrams illustrating communication between NETCONF SERVER/O-RU and NETCONF client during fault/alarm generation, according to prior art.

FIG. 3 illustrates an O-RAN system (or O-RAN), according to the present disclosure.

FIG. 4a illustrates a hierarchical model used in FIG. 3, according to the present disclosure.

FIG. 4b illustrates a hybrid model used in FIG. 3, according to the present disclosure.

FIG. 5 illustrates a fault management system, according to the present disclosure.

FIG. 6 is a sequence diagram illustrating communication between the NETCONF SERVER/O-RU and the NETCONF client during the fault/alarm generation using a second alarm list, according to the present disclosure.

FIG. 7 is a sequence diagram illustrating communication between the NETCONF SERVER/O-RU and the NETCONF client during the fault/alarm generation using both a first alarm list and the second alarm list, according to the present disclosure.

FIG. 8 is a flowchart illustrating a method for fault/alarm generation management, according to the present disclosure.

### DETAILED DESCRIPTION

In the following detailed description of the invention, numerous specific details are set forth in order to provide a thorough understanding of the invention. However, it will be obvious to a person skilled in the art that the invention may be practiced with or without these specific details. In other instances, well known methods, procedures and components have not been described in detail so as not to unnecessarily obscure aspects of the invention.

Furthermore, it will be clear that the invention is not limited to these alternatives only. Numerous modifications, changes, variations, substitutions and equivalents will be apparent to those skilled in the art, without parting from the scope of the invention.

The accompanying drawings are used to help easily understand various technical features and it should be understood that the alternatives presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Standard networking terms and abbreviations:

Networking Device: (acting as a client device). Network devices, or networking hardware, are physical devices that are required for communication and interaction between hardware on a computer network.

SFTP Server: known as the SSH (secure shell) file transfer protocol, or the secure file transfer protocol. SFTP requires authentication by the server. The data transfer takes place over a secure SSH channel It leverages a set of utilities that provide secure access to a remote computer to deliver secure communications. It is considered by many to be the optimal method for secure file transfer. It leverages SSH (Secure Socket Shell or Secure Shell) and is frequently also referred to as ‘Secure Shell File Transfer Protocol’.

NETCONF: NETCONF is a protocol defined by the IETF to “install, manipulate, and delete the configuration of network devices”. NETCONF operations are realized on top of a Remote Procedure Call (RPC) layer using an XML encoding and provide a basic set of operations to edit and query configuration on a network device.

Server (residing in networking devices like) (O-RU/O-DU): The Server can be a Switch, Router, Commercially Off-the-shelf Servers, Open Distributed Units, Open Radio Units, etc.

Client (EMS/SMO/O-DU): The Client here can be a user over Element Management System (EMS), Service Management and Orchestration (SMO), Open Distributed Unit (O-DU), Open Radio Unit (O-RU) Controller or any other NETCONF client accessing the NETCONF server.

Active-alarm-list: It is a list which contains active alarms due to the existing faults.

gNB: New Radio (NR) Base stations which have the capability to interface with 5G Core named as NG-CN over NG-C/U (NG2/NG3) interface as well as 4G Core known as Evolved Packet Core (EPC) over S1-C/U interface.

LTE eNB: An LTE eNB is evolved eNodeB that can support connectivity to EPC as well as NG-CN.

Non-standalone NR: It is a 5G Network deployment configuration, where a gNB needs an LTE eNodeB as an anchor for control plane connectivity to 4G EPC or LTE eNB as an anchor for control plane connectivity to NG-CN.

Standalone NR: It is a 5G Network deployment configuration where gNB does not need any assistance for connectivity to the core network, it can connect on its own to NG-CN over NG2 and NG3 interfaces.

Non-standalone E-UTRA: It is a 5G Network deployment configuration where the LTE eNB requires a gNB as an anchor for control plane connectivity to NG-CN.

Standalone E-UTRA: It is a typical 4G network deployment where a 4G LTE eNB connects to EPC.

Xn Interface: It is a logical interface that interconnects the New RAN nodes i.e., it interconnects gNB to gNB and LTE eNB to gNB and vice versa.

Reference signal received power (RSRP): RSRP may be defined as the linear average over the power contributions (in [W]) of the resource elements that carry cell-specific reference signals within the considered measurement frequency bandwidth.” RSRP may be the power of the LTE Reference Signals spread over the full bandwidth and narrowband.

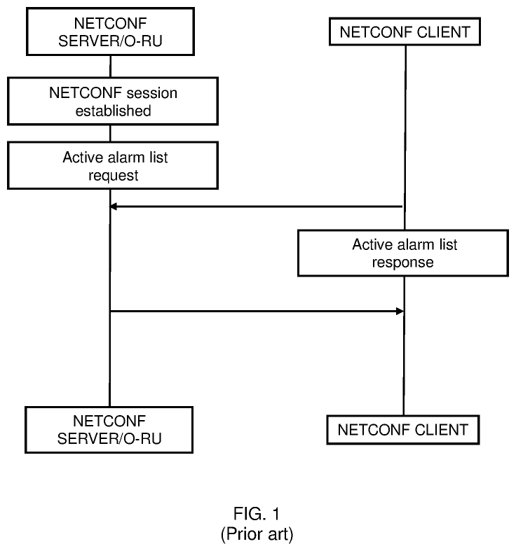

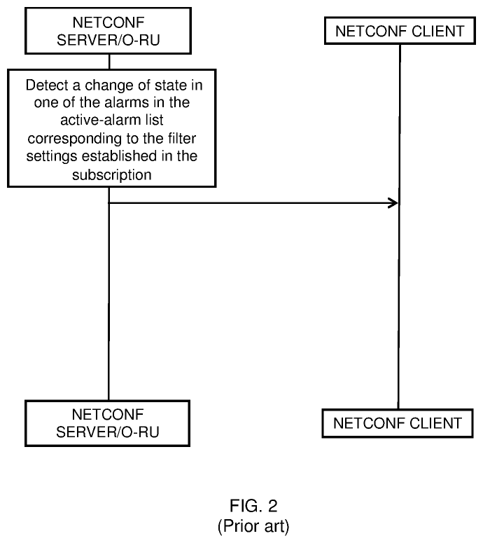

As seen in FIGS. 1 and 2, generally, active alarms except for the alarms with ‘Warning’ as severity on a server are reported to a client with the help of Notifications supported by NetCONF/RestCONF protocol and the Alarm data is kept into a list containing the currently active alarms on the server. Once the Alarms are cleared from the server, a notification is sent to the client and the entry from Active Alarms is removed.

However, there is no record of all the generated and/or cleared alarms for retrieval by the user at a later time. Further, there may arise a situation when the connection of the Client (EMS/SMO/O-DU) to the Management Interface (the server (at O-RU)) is lost for a while, and in this case some alarm or fault (like temperature increase, and other +20 alarms as per M-plane specification O-RAN.WG4.MP.0-v07.00.00 (Annex A)) fluctuated (at O-RU) i.e., raised and cleared simultaneously (due to a bug or due to higher priority alarm, hardware issues, fault no longer exist), the Client (EMS/SMO/O-DU) will not be able to detect the fault which caused the alarm to rise, even after the connection to the M-Plane is back alive. Also, due to this unavailability of historical alarms, units that may be deployed at the Client (EMS/SMO/O-DU), which support AI (artificial intelligence) and ML (machine learning), will not be able to work efficiently in anticipating future issues and being ready to resolve them.

The present disclosure solves the above stated problems by creating a historical log of alarms (first alarm list) in a server when they were raised (i.e., activated) and when they were cleared (deactivated/resolved), with all the alarm details along with their timestamps so the log can be transferred to the client, either periodically or when required.

The present disclosure provides a method in a Networking Device (acting as a server) for maintaining a log of all alarms generated due to faults detected in the system/device. The networking device might encounter a fault and generate an alarm in the system (software/hardware) and require to send the alarm notification/information as an update to another networking device (acting as a client device). The client-Server relationship is maintained over NetCONF/RestCONF protocol. The server can be a switch, router, commercially off-the-shelf servers, open distributed units, open radio units etc. The client here can be a user over Element Management System (EMS), Service Management and Orchestration (SMO), Open Distributed Unit (O-DU), Open Radio Unit (O-RU) controller or any other NetCONF client accessing the NetCONF server (residing in networking devices like a switch, a router, commercially off-the-shelf servers, open distributed units, open radio units etc.) over Secure Shell (SSH) protocol. The present disclosure supports creating a historical log of alarms (first alarm list) in a server, when they were raised and when they were cleared, with all the alarm details along with their timestamps so the log can be transferred to the client, either periodically or when required. The AI and ML unit (at the client (EMS/SMO/O-DU)) can use the historical logs in order to train the model and work efficiently in anticipating future issues and being ready to resolve them.

Referring to FIGS. 1 and 2, when the connection of the Client (EMS/SMO/O-DU) to the Management Interface (the server (at O-RU) is lost for a while, and in case some alarm or fault (like temperature increase, and other +20 alarms as per M-plane specifications O-RAN.WG4.MP.0-v07.00.00 (Annex A)) fluctuated (at O-RU) i.e., raised and cleared simultaneously (due to a bug or due to higher priority alarm, hardware issues, fault no longer exist). In this case, the Client (EMS/SMO/O-DU) will not be able to detect the fault which caused the alarm to rise, even after the connection to M Plane is back alive. Also, due to this unavailability of historical alarms, the AI and ML units/systems (at the Client (EMS/SMO/O-DU)) will not be able to work efficiently in anticipating future issues and being ready to resolve them.

This issue is overcome by the proposed fault management system in that the created historical alarms list can be used in debugging issues that could get really difficult if we can only see the active alarms in the system. Since (as described in FIGS. 1 and 2) it is only the active alarms list that is available at the server (at O-RU) which is used to report the active alarms in the system along with their respective Severities and the Source modules detected by the system.

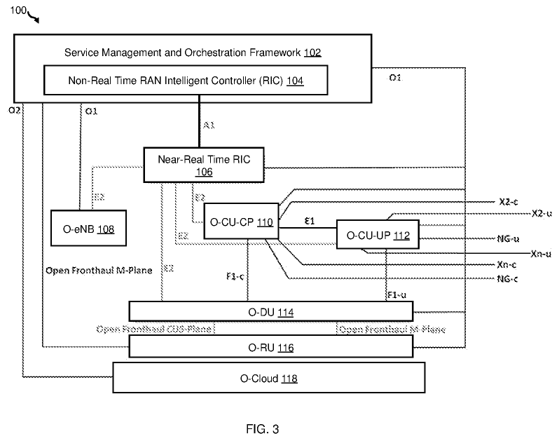

Referring now to the drawings, and more particularly to FIGS. 3 through 8.

FIG. 3 illustrates an O-RAN system (or O-RAN) 100 according to the present disclosure.

A radio access network (RAN) is a part of a telecommunications system which connects individual devices to other parts of a network through radio connections. The RAN provides a connection of user equipment (UE) such as mobile phones or computers with a core network of telecommunication systems. The RAN is an essential part of the access layer in the telecommunication systems which utilizes base stations (such as e node B, g node B) for establishing radio connections. The O-RAN (Open-Radio Access Network) 100 is an evolved version of prior radio access networks, making the prior radio access networks more open and smarter than previous generations. The O-RAN provides real-time analytics that drives embedded machine learning systems and artificial intelligence back-end modules to empower network intelligence. Further, the O-RAN includes virtualized network elements with open and standardized interfaces. The open interfaces are essential to enable smaller vendors and operators to quickly introduce their services or enable operators to customize the network to suit their own unique needs. Open interfaces also enable multivendor deployments, enabling a more competitive and vibrant supplier ecosystem. Similarly, open-source software and hardware reference designs enable faster, more democratic, and permission-less innovation. Further, the O-RAN introduces a self-driving network by utilizing new learning-based technologies to automate operational network functions. These learning-based technologies make the O-RAN intelligent. Embedded intelligence, applied at both component and network levels, enables dynamic local radio resource allocation and optimizes network-wide efficiency. In combination with O-RAN's open interfaces, AI-optimized closed-loop automation is a new era for network operations.

The O-RAN 100 may comprise a Service Management and Orchestrator (SMO) (can also be termed as “Service Management and Orchestration Framework”) 102, a Non-Real Time RAN Intelligent Controller (Non-RT-RIC) 104 residing in the SMO 102, a Near-Real Time RAN Intelligent Controller (Near-RT-RIC) 106, an Open Evolved NodeB (O-eNB) 108, an Open Central Unit Control Plane (O-CU-CP) 110, an Open Central Unit User Plane (O-CU-UP) 112, an Open Distributed Unit (O-DU) 114, an Open Radio Unit (O-RU) 116 and an Open Cloud (O-Cloud) 118.

The SMO 102 is configured to provide SMO functions/services such as data collection and provisioning services of the ORAN 100. The data collection of the SMO 102 may include, for example, data related to a bandwidth of a wireless communication network and at least one of a plurality of user equipments (not shown in figures). That is, the SMO 102 oversees all the orchestration aspects, management and automation of ORAN elements and resources and supports O1, A1 and O2 interfaces.

The Non-RT-RIC 104 is a logical function that enables non-real-time control and optimization of the ORAN elements and resources, AI/ML workflow including model training and updates, and policy-based guidance of applications/features in the Near-RT RIC 106. It is a part of the SMO Framework 102 and communicates to the Near-RT RIC using the A1 interface. The Near-RT-RIC 106 is a logical function that enables near-real-time control and optimization of the O-RAN elements and resources via fine-grained data collection and actions over an E2 interface.

Non-Real Time (Non-RT) control functionality (>1 s) and Near-Real Time (Near-RT) control functions (<1 s) are decoupled in an RIC (RAN Intelligent Controller). The Non-RT functions include service and policy management, RAN analytics and model-training for some of the near-RT RIC functionality, and non-RT RIC optimization.

The O-eNB 108 is a hardware aspect of a fourth generation RAN that communicates with at least one of the plurality of user equipments (not shown in figures) via wireless communication networks such as a mobile phone network. The O-eNB 108 is a base station and may also be referred to as e.g., evolved Node B (“eNB”), “eNodeB”, “NodeB”, “B node”, gNB, or BTS (Base Transceiver Station), depending on the technology and terminology used. The O-eNB is a logical node that handles the transmission and reception of signals associated with a plurality of cells (not shown in figures). The O-eNB 108 supports O1 and E2 interfaces to communicate with the SMO 102 and the Near-RT-RIC 106 respectively.

Further, an O-CU (Open Central Unit) is a logical node hosting RRC (Radio Resource Control), SDAP (Service Data Adaptation Protocol), and PDCP (Packet Data Convergence Protocol). The O-CU is a disaggregated O-CU and includes two sub-components: O-CU-CP 110 and O-CU-UP 112. The O-CU-CP 110 is a logical node hosting the RRC and the control plane part of the PDCP. The O-CU-CP 110 supports O1, E2, F1-c, E1, X2-c, Xn-c and NG-c interfaces for interaction with other components/entities.

Similarly, the O-CU-UP 112 is a logical node hosting the user plane part of the PDCP and the SDAP and uses O1, E1, E2, F1-u, X2-u, NG-u and Xn-u interfaces.

The O-DU 114 is a logical node hosting RLC/MAC (Medium access control)/High-PHY layers based on a lower layer functional split and supports O1, E2, F1-c, F1-u, OFH CUS-Plane and OFH M-Plane interfaces.

The O-RU 116 is a logical node hosting Low-PHY layer and RF (Radio Frequency) processing based on a lower layer functional split. This is similar to 3GPP's “TRP (Transmission And Reception Point)” or “RRH (Remote Radio Head)” but more specific in including the Low-PHY layer (FFT/iFFT, PRACH (Physical Random Access Channel) extraction). The O-RU 116 utilizes OFH CUS-Plane and OFH M-Plane interfaces.

The O-Cloud 118 is a collection of physical RAN nodes (that host various RICs, CUs, and DUs), software components (such as operating systems and runtime environments) and the SMO 102, where the SMO manages and orchestrates the O-Cloud 118 from within via O2 interface.

Now referring to the various interfaces used in the ORAN 100 as mentioned above.

The O1 interface is element operations and management interface between management entities in the SMO 102 and O-RAN managed elements, for operation and management, by which FCAPS (fault, configuration, accounting, performance, security) management, Software management, File management shall be achieved. The O-RAN managed elements include the Near RT-RIC 106, the O-CU (the O-CU-CP 110 and the O-CU-UP 112), the O-DU 114, the O-RU 116 and the O-eNB 108. The management and orchestration functions are received by the aforesaid O-RAN managed elements via the O1 interface. The SMO 102, in turn, receives data from the O-RAN managed elements via the O1 interface for AI model training.

The O2 interface is a cloud management interface, where the SMO 102 communicates with the O-Cloud 118 it resides in. Typically, operators that are connected to the O-Cloud 118 can then operate and maintain the O-RAN 100 with the O1 or O2 interfaces.

The A1 interface enables the communication between the Non-RT-RIC 104 and the Near-RT-RIC 106 and supports policy management, machine learning and enrichment information transfer to assist and train AI and machine learning in the Near-RT-RIC 106.

The E1 interface connects the two disaggregated O-CUs i.e., the O-CU-CP 110 and the O-CU-UP 112 and transfers configuration data (to ensure interoperability) and capacity information between the O-CU-CP 110 and the O-CU-UP 112. The capacity information is sent from the O-CU-UP 112 to the O-CU-CP 110 and includes the status of the O-CU-UP 112.

The Near-RT-RIC 106 connects to the O-CU-CP 110, the O-CU-UP 112, the O-DU 114 and the O-eNB 108 (combinedly called as an E2 node) with the E2 interface for data collection. The E2 node can connect only to one Near-RT-RIC, but one Near-RT-RIC can connect to multiple E2 nodes. Typically, protocols that go over the E2 interface are control plane protocols that control and optimize the elements of the E2 node and the resources they use.

The F1-c and F1-u interfaces (combinedly an F1 interface) connect the O-CU-CP 110 and the O-CU-UP 112 to the O-DU 114 to exchange data about frequency resource sharing and network statuses. One O-CU can communicate with multiple O-DUs via F1 interfaces.

Open fronthaul interfaces i.e., the OFH CUS-Plane (Open Fronthaul Control, User, Synchronization Plane) and the OFH M-Plane (Open Fronthaul Management Plane) connect the O-DU 114 and the O-RU 116. The OFH CUS-Plane is multi-functional, where the control and user features transfer control signals and user data respectively and the synchronization feature synchronizes activities between multiple RAN devices. The OFH M-Plane optionally connects the O-RU 116 to the SMO 102. The O-DU 114 uses the OFH M-Plane to manage the O-RU 116, while the SMO 102 can provide FCAPS (fault, configuration, accounting, performance, security) services to the O-RU 116.

An X2 interface is broken into the X2-c interface and the X2-u interface. The former is for the control plane and the latter is for the user plane that sends information between compatible deployments, such as a 4G network's eNBs or between an eNB and a 5G network's en-gNB.

Similarly, an Xn interface is also broken into the Xn-c interface and the Xn-u interface to transfer control and user plane information respectively between next generation NodeBs (gNBs) or between ng-eNBs or between the two different deployments.

The NG-c (control plane interface) and the NG-u (user plane interface) connect the O-CU-CP 110 and the O-CU-UP 112 respectively to a 5G core. The control plane information is transmitted to a 5G access and mobility management function (AMF) that receives connection and session information from the user equipment and the user plane information is relayed to a 5G user plane function (UPF), which handles tunnelling, routing and forwarding, for example.

Now referring to the SMO 102, the O-DU 114 and the O-RU 116. In the management plane (M-Plane), the O-DU 114 and the SMO 102 are used to manage the O-RU 116 (or O-RUs), wherein the O-DU 114 and the SMO 102 use NETCONF (Network Configuration Protocol) to manage the O-RU 116. Alternatively, the O-DU 114 and other NMSs (Network Management Systems) may manage the O-RU 116 via NETCONF. In such a case, the SMO 102 (or the NMS) corresponds to a NETCONF client while the O-RU 116 corresponds to a NETCONF server and the O-DU 114 can act as both the NETCONF client and the NETCONF server depending on the model (explained below).

In general, NETCONF is a network management protocol defined by the Internet Engineering Task Force to manage, install, manipulate, and delete the configuration of network devices. NETCONF operations are realized on top of a Remote Procedure Call (RPC) layer using an XML (Extensible Markup Language) encoding and provide a basic set of operations to edit and query configuration on a network device. NETCONF runs primarily over Secure Shell (SSH) transport. The protocol messages are exchanged on top of a secure transport protocol. Further, NETCONF reports management information that is useful to NNMi (Network Node Manager). In terms of SDN (Software Defined Networks), NETCONF is usually referenced as a southbound API (Application Programming Interface) from an SDN controller to network agents like switches and routers due to its potential for supporting multi-vendor environments.

The O-RU 116, which is the NETCONF server herein, may be managed using management models namely hierarchical model and hybrid model.

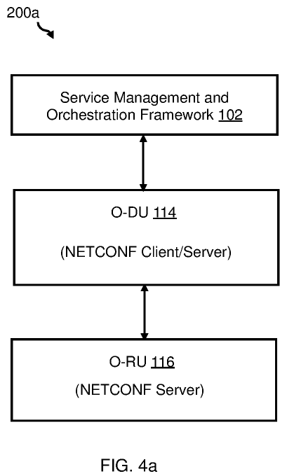

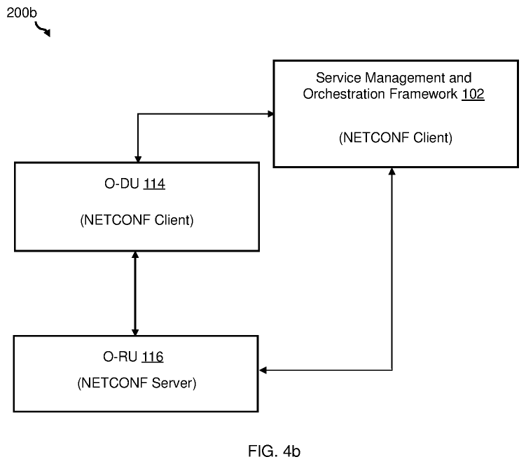

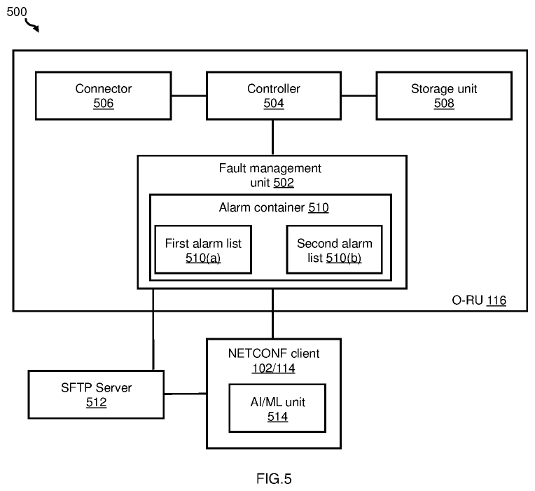

FIG. 4a illustrates the hierarchical model 200a and FIG. 4b illustrates the hybrid model 200b. In the hierarchical model 200a, the O-RU 116 (subordinate O-RU) is managed by the O-DU 114 which in turn is managed by the SMO 102. The O-DU 114 may act as both NETCONF client (to the O-RU) and NETCONF server (to the SMO to reduce processing load), the SMO 102 as NETCONF client and the O-RU 116 as NETCONF server.

In the hybrid model 200b, the O-RU 116 is managed by one or more NMSs or the SMO 102 in addition to the O-DU 114. An advantage of this model is that the SMO 102 can monitor/control other network devices in addition to the O-RU 116 enabling uniform maintenance, monitoring, and control of all. The O-DU 114 and the SMO 102 work as NETCONF client and the O-RU 116 as NETCONF server.

The terms “NETCONF server” and “server” may interchangeably be used throughout the present disclosure. Further, the terms “NETCONF client” and “client” may interchangeably be used throughout the present disclosure.

Further, the O-RU 116 comprises a fault management unit (FMU, as explained below) that is responsible for sending alarm notifications to the configured subscriber (in this case, which will typically be the NETCONF Client unless the O-RU 116 supports the configured subscription capability, when the configured subscriber may be an Event-Collector. FMU contains Fault Management Managed Element and via this Managed Element alarm notifications can be disabled or enabled.

For example, alarms may be reported in the following scenarios:

In many cases, the alarm detection method is hardware (HW) specific. It is assumed that the alarm detection method is reliable to avoid undetected alarms and false alarms. It is also expected that the NETCONF server is applying mechanisms to avoid unreasonably fast toggling of alarms' state. Further, it is to be noted that alarms that are not applicable in the given HW design or SW (software) configuration shall not be reported. For example, alarms related to fan monitoring apply to HW variants with fans.

The example alarms table has the following columns

Fault id—Numerical identifier of alarm. This ID shall be used in <alarm-notif> message (fault-id parameter).

Name—Name of the alarm.

Meaning—Description of alarm, describes the high-level meaning of the alarm Start condition—Defines conditions which must be fulfilled to generate an alarm. If filtering time is needed, then it must be defined in this column.

Cancel condition—Defines conditions which must be fulfilled to cancel the alarm. If filtering time is needed, then it must be defined in this column

NETCONF server actions on detection—Defines actions of the NETCONF Server after the alarm has been detected.

NETCONF Server actions on cancel—Defines actions of NETCONF Server after the alarm has been cancelled.

System recovery actions—Describes gNB level recovery actions of the NETCONF Client after the alarm has been indicated by NETCONF Server. This field is informative only; actions taken by the NETCONF Client are not restricted nor defined in this document. System recovery action “Reset” refers to NETCONF Client forcing a reset of O-RU.

Source—Defines possible sources of the alarm (alarm is within O-RU).

If Source will not fit into (in) any of the above or is empty, it means that external devices (like Antenna Line Devices) cause an alarm (the fault is out of the O-RU). Then additional text in alarm notification is needed to clearly say what may be a possible fault source.

Severity—Defines the severity of the alarm.

Critical—sub unit for which alarm has been generated is not working and cannot be used.

Major—sub unit for which alarm has been generated is degraded, it can be used but performance might be degraded.

Minor—sub unit for which alarm has been generated is still working.

FIG. 5 illustrates a fault management system 500. The fault management system 500 may comprise the O-RU 116, an SFTP server 512 and the NETCONF client (or client) 102/114.

Referring to FIG. 5, the O-RU 116 may comprise a fault management unit (FMU) 502, at least one processor and/or controller 504, a connector 506 and a storage unit 508. However, the components of the O-RU 116 are not limited to the above-described example, and for example, the O-RU 116 may include more or fewer components than the illustrated components. In addition, the fault management unit 502, the controller 504, the connector 506, and the storage unit 508 may be implemented in the form of a single chip.

The fault management unit (FMU) 502 may manage the O-RU faults through the NETCONF client using the M-plane through a YANG model. To manage the faults, the FMU 502 may establish the client-server relationship over HTTP-based Representational State Transfer Configuration Protocol (RESTCONF) protocol. The RESTCONF provides a programmatic interface based on standard mechanisms for accessing configuration data, state data, data-model-specific Remote Procedure Call (RPC) operations, and events, defined in the YANG model. The FMU 502 directs the control of the operational information of at least one of the following: networking device acting as a client device, and another as a server device, encountering a fault, generating an alarm, and sending the alarm as an update to the networking device.

The FMU 502 comprises an alarm container (or alarm list container) 510 that includes a first alarm list 510(a) and a second alarm list 510(b). The first alarm list 510(a) is created to include a list of historic-alarms (i.e., first alarm list) encompassing a log of all the historic information pertaining to the raising and clearing of alarms along with their timestamps. All the details should be present when the alarm is raised or cleared. In one aspect, the historical logged information can be associated with any one or both of activation and deactivation of the at least one alarm. The historical logged information associated with the activation comprises at least one of time stamp information of an alarm activation and operation failure information causing the alarm activation. Further, the historical logged information associated with the deactivation comprises the time stamp information of an alarm deactivation.

The second alarm list 510(b) is created simultaneously to include a second set of information indicating a list of active alarms (i.e., currently being activated due to fault detection and are in queue to be solved) i.e., second alarm list encompassing a log of all the information pertaining to the raising and clearing of the active alarms.

Further, the FMU 502 may be configured to provide access to the alarm container 510 in order to access the first alarm list.

The advantage of creating the first alarm list 510(a) is that limited memory constraints at the O-RU/O-DU (at which the server resides) may be fixed by rolling over the alarm logs without any information to one or more clients (interchangeably “client(s)”). The alarm logs/list (includes the first alarm list, the second alarm list or any other list) may be automatically transferred to the client after the addition of a fixed number of entries (alarms raised and cleared) in the alarm list. The alarm logs may be automatically transferred to the client on a regular basis after a fixed interval of time. The time interval should be less than the time in which the memory gets near full (80%). For example, the time interval is a variable which depends on the number of entries (alarms raised and cleared), types of alarms, etc. The alarm logs will be rolled over (new entries will be overwritten over the older entries in a queue fashion and the data corresponding to the older entries will be lost) or the memory is cleared after sending to the client(s). Further, the alarm logs may be just rolled after receiving confirmation from the client(s). This is in the condition when there is a connection loss at the time when the alarm logs were to be transferred to the client.

Further, the limited memory constraints at the O-RU/O-DU (at which the server resides) may be fixed in that: the O-RU 116 would not delete the entries until it receives acknowledgement of successful transfer from the client. Further, the logs will be automatically transferred to the client when the server memory gets full. The alarm logs will be rolled over or a memory (the storage unit 508) at the O-RU 116 is cleared after sending to the client(s). Further, the alarm logs may be just rolled after receiving confirmation from the client(s). The O-RU 116 (server) can send a notification to the client that memory is getting full (may be at 80% memory, etc.) and the logs will be rolled over if not copied. In this case, the client can send a request to the server for the logs if required and the logs will be rolled over or the memory is cleared after sending to the client(s), or otherwise, the server will roll over the log if it does not receive a request from the client, within a specific time period of sending the notification, which shows that the log is not required at the client end.

Furthermore, the limited memory constraints at the O-RU/O-DU (at which the server resides) may be fixed in that the client subscribes to the server for getting notifications related to historical alarm logs, the server will copy the historical logged information (historical logs or historical alarm logs) to the SFTP server 512 before clearing the same and will share the path of the copied location of the SFTP server 512 to all the connected clients (one or more connected clients) through notification. In case of connection loss, and the server is not able to share the SFTP server path as notification, the historical logs and/or the path of the copied location will also be made available as an attribute in the alarm container 510. A notification with the path of the copied location may be transmitted to the one or more connected clients when the historical logged information is copied to a remote location on the SFTP server 512.

An artificial intelligence/machine learning (AI/ML) unit 514 at the client (i.e., SMO/O-DU) can utilize the first alarm list i.e., historical logs to train the model, identifies at least one future failure event associated with the at least one alarm using the first alarm list, and determines at least one resolution to the at least one future failure event. Thus, with the aid of the AI/ML unit, the proposed fault management system may effectively anticipate the faults and provide/identify the resolution in prior for such anticipated faults.

The controller 504 may control a series of processes so that the FMU 502 of the O-RU 116 can operate according to the description described above. For example, the controller 504 may transmit/receive the connection information through the connector 506. There may be a plurality of controllers 504, and the controller 504 may perform a component control operation of the O-RU 116 by executing a program stored in the storage unit 508.

The storage unit 508 may store the alarm lists of the alarm container 510, programs and data necessary for the operation of the O-RU 116. The storage unit 508 may be composed of a storage medium such as read only memory (ROM), random access memory (RAM), hard disk, compact disc ROM (CD-ROM), and digital versatile disc (DVD), or a combination of storage media. Also, there may be a plurality of storage units 508. The FMU 502 may be configured to maintain the historical alarms list in volatile memory or RAM as the rest of the configuration, as a backup until the next hardware restart. Further, the FMU 502 can be configured to maintain the historical alarms list in non-volatile memory (NVM) or ROM as part of the persistent configuration, so as to keep the backup even after hardware restart. This aids in debugging issues due to sudden restart/failure of the O-RU 116 or the hardware in a scenario where it was not able to send the alarm to the client or management interface.

The connector 506 may be a device that connects the O-DU 114 and the O-RU 116 and may perform physical layer processing for message transmission and reception.

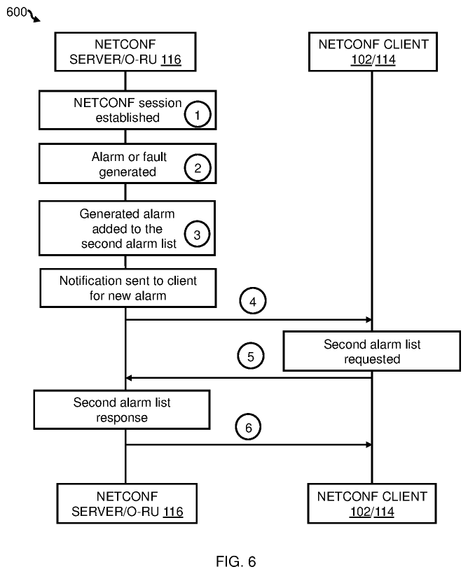

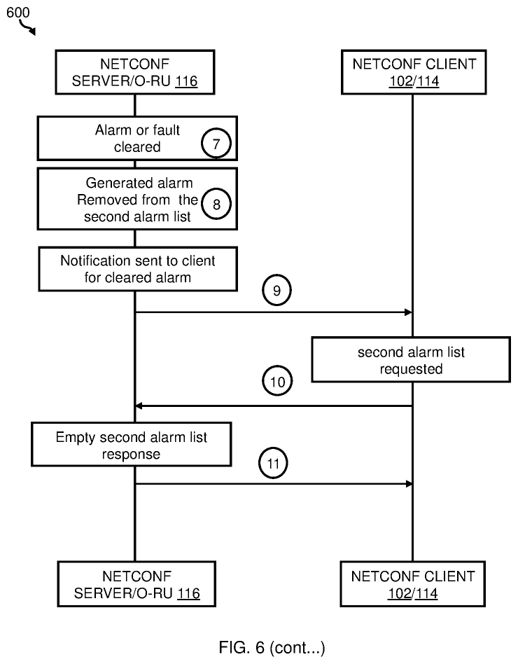

FIG. 6 is a sequence diagram 600 illustrating communication between the NETCONF SERVER/O-RU (or server) and NETCONF client (or client) during the fault/alarm generation using a second alarm list, according to the present disclosure. As per the latest O-RAN fault management Yang model (at the server (at O-RU)), o-ran-fm.yang, the high-level container is named ‘active-alarm-list’ i.e., second alarm list., (which contains active alarms due to the existing faults) and has only one member as a list of ‘active-alarms’.

At step 1, when the NETCONF server/O-RU 116 establishes a connection with the NETCONF client (102 or 114), the NETCONF server automatically sends alarm notifications to the NETCONF client (102 or 114).

At step 2, the O-RU 116 detects the fault and generates an alarm. At step 3, in response to detecting the generated fault or alarm, the generated alarm is added to the second alarm list. At step 4, the O-RU 116 may be configured to transmit the notification to the client 102/114 indicating that a new alarm has been generated. At step 5, the client 102/114 may then be configured to transmit a request to share the second alarm list stored in the O-RU 116 and at step 6, the second alarm list is shared with the client 102/114.

At step 7, once the alarm or fault is cleared, the O-RU 116 removes (At step 8) the generated alarm or fault from the second alarm list and a notification regarding the cleared item is transmitted (At step 9) to the client 102/114.

At step 10, the client 102/114 requests the second alarm list which is now updated by clearing the aforementioned generated alarm. At step 11, the O-RU 116 therefore transmits an empty second alarm list response indicating that the generated alarm is cleared, unless there are any pending alarms to be cleared.

Unlike conventional mechanisms (as described in FIGS. 1 and 2), that disclose a networking device (O-RU) for maintaining a log of all alarms generated due to faults detected in the system/device, the proposed fault management system 500 discloses about maintaining ‘alarm-list’ to log all the alarms related information (raised/cleared) during a period of time, sending a notification when alarms are copied to a remote location with the complete path of copied location on cloud/SFTP server 512, adding a list of “Historical-alarm” to maintain all alarms (the raising and clearing) along with their timestamp and storing historical-alarm list in memory (volatile/non-volatile) to keep the backup.

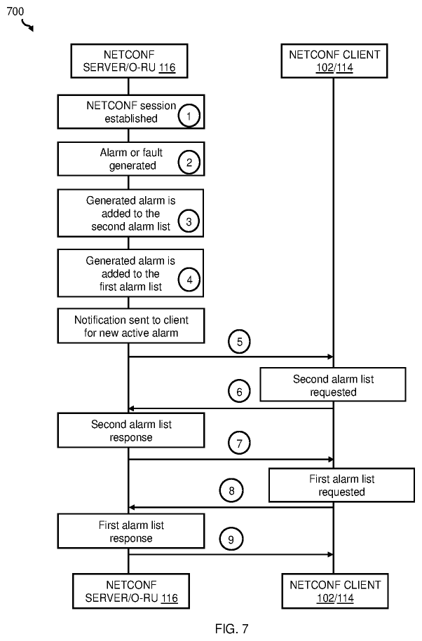

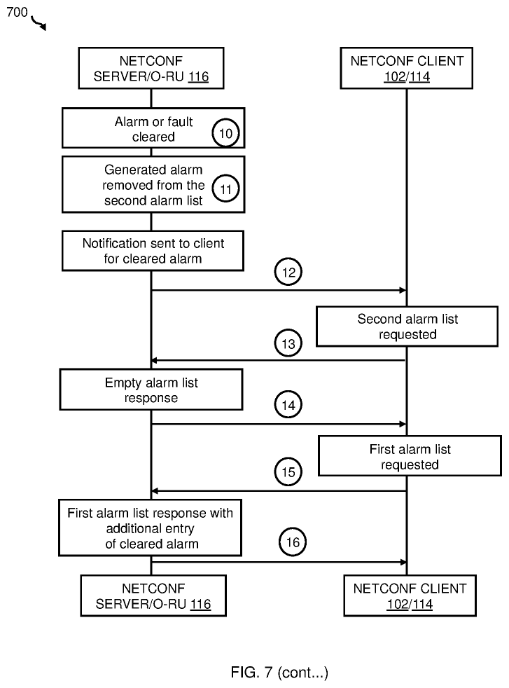

Thus, the proposed fault management system 500 creates a historical log of alarms in the server (O-RU 116), when they were raised and when they were cleared, with all the alarm details along with their timestamps so the log can be transferred to the client, either periodically or when required, as illustrated below in FIG. 7.

FIG. 7 is sequence diagram 700 for fault management session between the NETCONF server (i.e., the O-RU) 116 and the NETCONF client (i.e., the O-DU/SMO).

At step 1, the NETCONF server/O-RU 116 establishes a connection with the NETCONF client (102 or 114) and sends alarm notifications to the NETCONF client (102 or 114).

At step 2, the O-RU 116 detects the fault and generates an alarm. At step 3, in response to detecting the generated fault or alarm, the generated alarm is added to the second alarm list. Further, the generated alarm is added, at Step 4, to the first alarm list.

At step 5, the O-RU 116 may be configured to transmit the notification to the client 102/114 indicating that active alarms (i.e., second alarm list) have been generated.

At step 6, the client 102/114 may then be configured to transmit a request to share the second alarm list stored in the O-RU 116 and at step 7, the second alarm list is shared with the client 102/114.

Further, at step 8, the client 102/114 may then be configured to transmit a request to share the first alarm list stored in the O-RU 116 and at step 9, the first alarm list is shared with the client 102/114.

At step 10, once the alarm or fault is cleared, the O-RU 116 removes the generated alarm or fault from the second alarm list at step 11 and a notification regarding the cleared item is transmitted (at step 12) to the client 102/114.

At step 13, the client 102/114 requests the second alarm list which is now updated by clearing the aforementioned generated alarm. At step 14, the O-RU 116 therefore transmits an empty second alarm list response indicating that the generated alarm is cleared, unless there are any pending alarms to be cleared.

At step 15, the client 102/114 requests the first alarm list that is created by the O-RU 116. In response to the request, the O-RU 116 is configured to create the first alarm list response with an additional entry of cleared alarm (history of logged alarm events) and transmits (at step 16) the first alarm list to the client 102/114.

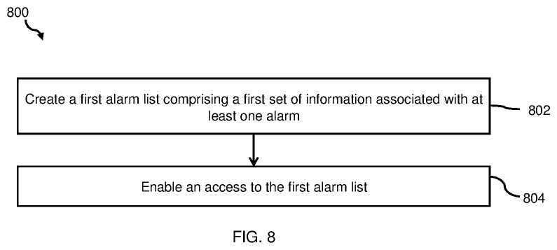

FIG. 8 is a flowchart 800 illustrating a method for managing logged information associated with at least one alarm. It may be noted that in order to explain the method steps of the flowchart 800, references will be made to the elements explained in FIG. 3 through FIG. 7.

At step 802, the method includes creating the first alarm list comprising a first set of information associated with the at least one alarm. The first set of information comprises the historical logged information associated with one of: activation and deactivation of the at least one alarm.

Further, at step 804, the method includes enabling the access to the first alarm list.

It may be noted that the flowchart 800 is explained to have above stated process steps; however, those skilled in the art would appreciate that the flowchart 800 may have more/less number of process steps which may enable all the above stated implementations of the present disclosure.

The various actions, acts, blocks, steps, or the like in the flow chart and sequence diagrams may be performed in the order presented, in a different order or simultaneously. Further, in some implementations, some of the actions, acts, blocks, steps, or the like may be omitted, added, modified, skipped, or the like without departing from the scope of the present disclosure.

The embodiments disclosed herein can be implemented using at least one software program running on at least one hardware device and performing network management functions to control the elements.

It will be apparent to those skilled in the art that other embodiments of the invention will be apparent to those skilled in the art from consideration of the specification and practice of the invention. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope of the invention. It is intended that the specification and examples be considered as exemplary, with the true scope of the invention being indicated by the claims.

The methods and processes described herein may have fewer or additional steps or states and the steps or states may be performed in a different order. Not all steps or states need to be reached. The methods and processes described herein may be embodied in, and fully or partially automated via, software code modules executed by one or more general purpose computers. The code modules may be stored in any type of computer-readable medium or other computer storage device. Some or all of the methods may alternatively be embodied in whole or in part in specialized computer hardware.

The results of the disclosed methods may be stored in any type of computer data repositories, such as relational databases and flat file systems that use volatile and/or non-volatile memory (e.g., magnetic disk storage, optical storage, EEPROM and/or solid-state RAM).

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components or any combination thereof designed to perform the functions described herein. A general-purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “may,” “might,” “may,” “e.g.,” and the like, unless specifically stated otherwise, or otherwise understood within the context as used, is generally intended to convey that certain alternatives include, while other alternatives do not include, certain features, elements and/or steps. Thus, such conditional language is not generally intended to imply that features, elements and/or steps are in any way required for one or more alternatives or that one or more alternatives necessarily include logic for deciding, with or without other input or prompting, whether these features, elements and/or steps are included or are to be performed in any particular alternative. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain alternatives require at least one of X, at least one of Y, or at least one of Z to each be present.

While the detailed description has shown, described, and pointed out novel features as applied to various alternatives, it can be understood that various omissions, substitutions, and changes in the form and details of the devices or algorithms illustrated can be made without departing from the scope of the disclosure. As can be recognized, certain alternatives described herein can be embodied within a form that does not provide all of the features and benefits set forth herein, as some features can be used or practiced separately from others.

We claim:

1. A method for managing fault using logged information associated with at least one alarm in an open radio access network (O-RAN) (100), the method implemented at a NETCONF server (116) and the method comprising:
creating a first alarm list (510(a)) comprising a first set of information associated with the at least one alarm, wherein the first set of information comprises a historical logged information associated with any one or both of activation and deactivation of the at least one alarm; and
enabling an access to the first alarm list.

2. The method as claimed in claim 1, wherein the historical logged information associated with the activation comprises at least one of: time stamp information of an alarm activation and operation failure information causing the alarm activation.

3. The method as claimed in claim 1, wherein the historical logged information associated with the deactivation comprises the time stamp information of an alarm deactivation.

4. The method as claimed in claim 1, wherein the method comprises:
maintaining a second set of information in a second alarm list (510(b)), wherein the second set of information comprises at least one active alarm.

5. The method as claimed in claim 1, wherein the method further comprises:
copying the historical logged information to an SFTP (Secure File Transfer Protocol) server (512) and transmitting a path of a copied location of the SFTP server to one or more connected clients (102/114).

6. The method as claimed in claim 5, wherein the method further comprises:
transmitting a notification with the path of the copied location to the one or more connected clients when the historical logged information is copied to a remote location on the SFTP server (512).

7. The method as claimed in claim 1, wherein enabling the access to the first alarm list comprises:
maintaining a client-server relationship over HTTP-based Representational State Transfer Configuration Protocol (RESTCONF) protocol; and
enabling the access to the first alarm list using the RESTCONF protocol, wherein the RESTCONF provides a programmatic interface based on standard mechanisms for accessing configuration data, state data, data-model-specific Remote Procedure Call (RPC) operations, and events, defined in YANG model.

8. The method as claimed in claim 7, wherein the method further comprises:
transmitting an alarm notification comprising affected objects indicating elements affected by a fault.

9. A fault management system (500) for managing fault using logged information associated with at least one alarm in an open radio access network (ORAN) (100), the fault management system (500) comprising:
a fault management unit (FMU) (502) configured to:
create a first alarm list comprising a first set of information associated with the at least one alarm, wherein the first set of information comprises a historical logged information associated with any one or both of activation and deactivation of the at least one alarm; and
enable access to the first alarm list.

10. The fault management system (500) as claimed in claim 9, wherein the historical logged information associated with the activation comprises at least one of: time stamp information of an alarm activation and operation failure information causing the alarm activation.

11. The fault management system (500) as claimed in claim 9, wherein the historical logged information associated with the deactivation comprises the time stamp information of an alarm deactivation.

12. The fault management system (500) as claimed in claim 9, wherein the FMU (502) is configured to:
maintain a second set of information in a second alarm list, wherein the second set of information comprises at least one active alarm.

13. The fault management system (500) as claimed in claim 9 further comprises an artificial intelligence/machine learning (AI/ML) unit (514) configured to:
identify at least one future failure event associated with the at least one alarm using the first alarm list; and
determine at least one resolution to the at least one future failure event.

14. The fault management system (500) as claimed in claim 9, wherein to enable the access to the first alarm list, the FMU (502) is configured to:
maintain a client-server relationship over HTTP-based Representational State Transfer Configuration Protocol (RESTCONF) protocol; and
enable the access to the first alarm list using the RESTCONF protocol, wherein the RESTCONF provides a programmatic interface based on standard mechanisms for accessing configuration data, state data, data-model-specific Remote Procedure Call (RPC) operations, and events, defined in YANG model.

15. The fault management system (500) as claimed in claim 14, wherein the FMU (502) is further configured to:
transmit an alarm notification comprising affected objects indicating elements affected by a fault.

16. The fault management system (500) as claimed in claim 9, wherein the FMU (502) is further configured to:
copy the historical logged information to an SFTP (Secure File Transfer Protocol) server (512) and share a path of a copied location of the SFTP server to one or more connected clients (102/114).

17. The fault management system (500) as claimed in claim 16, wherein the FMU (502) is further configured to:
transmit a notification with the path of the copied location to the one or more connected clients when the historical logged information is copied to a remote location on the SFTP server (512).
